(19) United States
(12) Patent Application Publication
(10) Pub. No.: US 2025/0308079 A1
(43) Pub. Date: Oct. 2, 2025

(54) Local Reconstruction of Remotely Rendered Digital Content

(71) Applicant: Advanced Micro Devices, Inc., Santa Clara, CA (US)

(72) Inventors: Mark Richard Nutter, Austin, TX (US); Aaron Michael Knoll, Salt Lake City, UT (US); Madhusudhanan Srinivasan, Dripping Springs, TX (US); Bihn Huy Le, Mountain View, CA (US)

(73) Assignee: Advanced Micro Devices, Inc., Santa Clara, CA (US)

(21) Appl. No.: 18/619,527

(22) Filed: Mar. 28, 2024

(51) Int. Cl. G06T 11/00; G06T 1/60; G06T 9/00

(52) U.S. Cl. CPC G06T 11/00; G06T 1/60; G06T 9/00; G06T 2200/16

(57) ABSTRACT

Local reconstruction techniques of remotely rendered digital content are described. In one or more examples, a device includes a decoder implemented in hardware and configured to generate a decoded digital image from an encoded digital image and a renderer implemented in hardware and configured to reconstruct a digital image from the decoded digital image by rendering the decoded digital image using a machine-learning model.

### BACKGROUND

A variety of types of digital content are communicated between entities in support of a variety of usage scenarios. A producer device, for instance, encodes the digital content for receipt by a client device. The client device then decodes the digital content for output, e.g., for rendering. The producer device, as part of encoding the digital content, utilizes techniques including compression, encryption, and digital rights management. Accordingly, the client device is also tasked with decoding the digital content using corresponding techniques. In some scenarios, however, inefficiencies occur that effect interactivity and quality of experience supported at the client device in interacting with the digital content due to resources consumed as part of encoding and decoding the digital content.

### BRIEF DESCRIPTION OF THE DRAWINGS

The detailed description is described with reference to the accompanying figures.

FIG. 1 is a block diagram of a non-limiting example system configured to employ local reconstruction techniques of remotely rendered digital content.

FIG. 2 depicts a non-limiting example showing operation of an encoder and decoder of a producer device and a client device of FIG. 1 in greater detail.

FIG. 3 depicts a non-limiting example showing operation of an image construction controller of a local renderer of FIG. 2 in greater detail.

FIG. 4 depicts a non-limiting example showing operation of an image construction controller of a local renderer of FIG. 2 in greater detail as part of an immersive environment.

FIG. 5 depicts a non-limiting example showing operation of a digital content source as capturing a digital image based a view plane defined in relation to the immersive environment.

### DETAILED DESCRIPTION

### Overview

Communication of digital content involves a producer device which is an entity (e.g., apparatus) that transmits the digital content and a client device which is an entity that receives the transmitted digital content, e.g., for display by a display device. Digital content is configurable in a variety of ways, including digital video, digital audio, digital media, digital documents, in support of enhanced immersive environments (e.g., as part of augmented reality and virtual reality) and so forth.

In a remote rendering example, rendering computations are offloaded from a client device and implemented at the producer device, e.g., a server. Remote rendering is typically performed to take advantage of increased amounts of computational resources available at the producer device, e.g., from graphics processing units and other functionality. To do so, the client device requests digital content from the producer device. The producer device then processes the request by executing a respective digital content source (e.g., application) to generate the digital content which is then rendered, e.g., as a stream of digital images forming frames of a digital video as pixels to a pixel buffer. The rendered stream of digital images is encoded and transmitted in this example to the client device, which then decodes the stream for display by a display device.

However, technical challenges occur in some real world scenarios as part of remote rendering. These technical challenges typically result from latency in communication of the digital content in response to inputs received from the client device (e.g., as part of a video game), bandwidth limitations imposed by use of data compression which may have a corresponding effect on quality of the digital content when displayed at the client device, and so forth.

To address these technical challenges, local reconstruction techniques of remotely rendered digital content are described. These techniques are usable to leverage rendering functionality, at least partially, at a client device to locally reconstruct digital content. Reconstruction of the digital content may be implemented in a variety of ways at the client device, an example of which includes execution of a machine-learning model as implementing generative artificial intelligence by one or more processing devices. By doing so, these techniques support improved interactivity and quality of experience for remotely rendered digital content that is scalable with computational capabilities available at a client device.

The client device is configurable in support of reconstructing a variety of functionality from encoded digital content received from a producer device. In a first example, the client device reconstructs high dynamic range (HDR) pixels from standard dynamic range (SDR) pixels included in the encoded digital content. In a second example, geometry buffer (i.e., “G-buffer”) assets are reconstructed from the encoded digital content that are usable to implement shading locally at the client device. The geometry buffer assets, for instance, are usable to define albedo, normal vectors, depth, or secularity of the one or more objects in an environment captured by a digital image that are used as a basis to implement shading within the environment. A variety of other examples are also contemplated, including implementation of image-based lighting (IBL), global illumination effects, transient illumination effects, and so forth as part of local rendering performed at the client device.

In this way, the local reconstruction techniques described herein address conventional technical challenges and improve operation of devices of that implement these techniques. A variety of other examples are also contemplated including implementation as part of immersive environments, examples of which are described in the following discussion and shown using corresponding figures.

In some aspects, the techniques described herein relate to a device including a decoder implemented in hardware and configured to generate a decoded digital image from an encoded digital image, and a renderer implemented in hardware and configured to reconstruct a digital image from the decoded digital image by rendering the decoded digital image using a machine-learning model.

In some aspects, the techniques described herein relate to a device, wherein the digital image is panoramic as capturing a plurality of viewpoints of an environment and the renderer is configured to adjust a respective said viewpoint with respect to the environment captured by the digital image.

In some aspects, the techniques described herein relate to a device, further including a sensor implemented in hardware to detect movement and wherein the renderer is configured to adjust the respective said viewpoint based on the detected movement.

In some aspects, the techniques described herein relate to a device, wherein the machine-learning model is configured to reconstruct high dynamic range pixels of the digital image from standard dynamic range pixels included in the encoded digital image.

In some aspects, the techniques described herein relate to a device, wherein the machine-learning model is configured to reconstruct illumination with respect to one or more objects in an environment captured by the digital image.

In some aspects, the techniques described herein relate to a device, wherein the machine-learning model is configured to reconstruct the illumination using image-based lighting (IBL) or cast a transient illumination effect back into the environment.

In some aspects, the techniques described herein relate to a device, wherein the machine-learning model is configured to reconstruct one or more geometry buffer assets from a geometry buffer configured to store geometric data of one or more objects in an environment captured by the digital image.

In some aspects, the techniques described herein relate to a device, wherein the one or more geometry buffer assets define albedo, normal vectors, depth, or secularity of the one or more objects in the environment.

In some aspects, the techniques described herein relate to a device, wherein the machine-learning model is configured to compute shading in the environment captured by the digital image using the one or more geometry buffer assets.

In some aspects, the techniques described herein relate to a device including an image conversion controller implemented in hardware and configured to receive a communication of client capability data describing machine-learning functionality supported by a client device and adapt conversion of a digital image into a rendered digital image based on the client capability data, and an encoder implemented in hardware and configured to generate an encoded digital image for receipt by the client device based on the rendered digital image.

In some aspects, the techniques described herein relate to a device, wherein the encoded digital image includes one or more geometry buffer assets from a geometry buffer configured to store geometric data of one or more objects.

In some aspects, the techniques described herein relate to a device, wherein the machine-learning functionality is configured to compute shading using the one or more geometry buffer assets.

In some aspects, the techniques described herein relate to a device, wherein the environment is a virtual reality environment and the encoded digital image supports an adjustment to a viewpoint with respect to the virtual reality environment based on movement detected by a sensor.

In some aspects, the techniques described herein relate to a device, wherein the machine-learning functionality is configured to reconstruct high dynamic range pixels from standard dynamic range pixels.

In some aspects, the techniques described herein relate to a device, wherein the machine-learning functionality is configured to reconstruct illumination with respect to one or more objects in the environment.

In some aspects, the techniques described herein relate to a device, wherein the machine-learning functionality is configured to reconstruct the illumination using image-based lighting (IBL).

In some aspects, the techniques described herein relate to a device, wherein the machine-learning functionality is configured to reconstruct one or more geometry buffer assets from a geometry buffer configured to store geometric data of one or more objects in the environment.

In some aspects, the techniques described herein relate to a device, wherein the encoded digital image is configured using path tracing and the machine-learning functionality, using generative artificial intelligence, is configured to smooth the path tracing.

In some aspects, the techniques described herein relate to a device including a decoder implemented in hardware and configured to generate a decoded digital image from an encoded digital image, and a renderer implemented in hardware and configured to render the decoded digital image, the rendering including reconstructing illumination of one or more objects within an environment captured by the encoded digital image.

In some aspects, the techniques described herein relate to a device, wherein the renderer is configured to reconstruct the illumination using image-based lighting (IBL) or cast a transient illumination effect back into the environment.

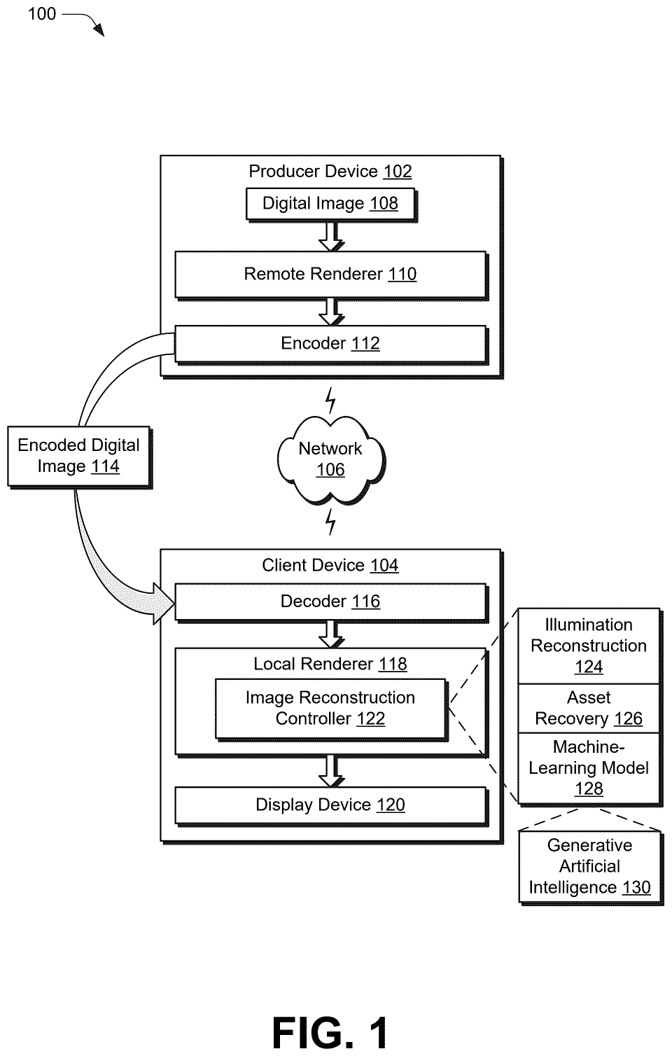

FIG. 1 is a block diagram of a non-limiting example system 100 configured to employ local reconstruction techniques of remotely rendered digital content. The system 100 includes a producer device 102 and a client device 104 that are communicatively coupled, one to another, using a network 106. The network 106, for example, is configurable as a local network, a global network (e.g., the internet), and so forth.

The producer device 102 and the client device 104 correspond to devices configured to interface with each other, e.g., using the network 106. Examples of those devices include, by way of example and not limitation, computing devices, servers, mobile devices (e.g., wearables, mobile phones, tablets, laptops), processors (e.g., graphics processing units, central processing units, and accelerators), digital signal processors, disk array controllers, hard disk drive host adapters, memory cards, solid-state drives, wireless communications hardware connections, Ethernet hardware connections, switches, bridges, network interface controllers, and other apparatus configurations. It is to be appreciated that in various implementations, the producer device 102 and client device 104 are configured as any one or more of those devices listed just above and/or a variety of other devices without departing from the spirit or scope of the described techniques.

The producer device 102 is configured remotely render digital content for consumption by the client device 104, the illustrated example of which is a digital image 108. Digital content may take a variety of other forms as previously described, examples of which include digital video, digital audio, digital media, digital documents, in support of enhanced immersive environments (e.g., as part of augmented reality and virtual reality), and so forth. The digital image 108, for example, is configurable as a frame of a digital video, e.g., in support of an immersive environment used to implement augmented reality, virtual reality, and so forth.

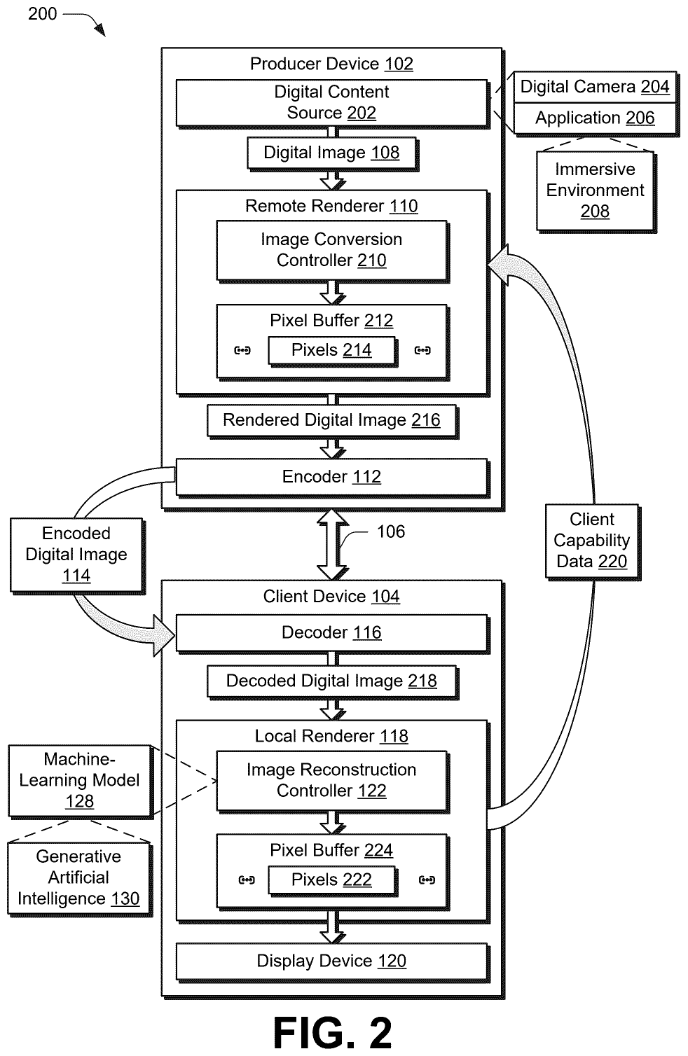

In the illustrated example, the producer device 102 includes a remote renderer 110 that is configured to render the digital image 108 into a form for display by a display device. The remote renderer 110 is configurable in hardware (e.g., using an integrated circuit, an application specific integrated circuit), a combination of software that is executed on the hardware (e.g., a central processing unit, graphics processing unit, or other auxiliary processing device), and so forth. The remote renderer 110, for instance, is implemented to rasterize the digital image 108 (e.g., into pixels) for display on a display device, further discussion of which is described in relation to FIG. 2. Through remote rendering, graphical computation is “offloaded” from the client device 104 to the producer device 102 to leverage increased functionality available at the producer device 102, e.g., graphics processing units and other processing functionality usable to perform graphical computations at a server.

The producer device 102 also includes an encoder 112 to encode the rendered digital image 108 to form an encoded digital image 114 for communication over the network 106 to the client device 104. The encoder 112 is configurable in hardware (e.g., using an integrated circuit, an application specific integrated circuit), a combination of software that is executed on the hardware (e.g., a central processing unit, graphics processing unit, or other auxiliary processing device), and so forth. The encoder 112, as part of encoding the digital content, is configurable to leverage techniques such as compression, encryption, and/or digital rights management such that the digital image 108 is optimized into a form suitable for communication via the network 106. Compression, for instance, is usable by the encoder 112 to increase transmission efficiency of the digital image 108 over the network 106. Portions of the encoded digital image 114, in one or more examples, are generated into respective communications (e.g., as packets, files, etc.) for transmission via signals over a transmission channel of the network 106 to the client device 104, e.g., using a wired or wireless connection.

The client device 104 then employs a decoder 116 to decode the encoded digital image 114. The decoder 116 is configurable in hardware (e.g., using an integrated circuit, an application specific integrated circuit), a combination of software that is executed on the hardware (e.g., a programmable decoder, a central processing unit, graphics processing unit, or other auxiliary processing device), and so forth. The decoder 116 is tasked with decoding the encoded digital image 114 using corresponding decompression, decryption, and/or digital rights management techniques utilized by the encoder 112 to generate the encoded digital image 114. The encoder 112 and decoder 116, for instance, are configured to support a variety of video encoding formats (e.g., MP4), video codecs (e.g., H.264), audio formats (e.g., MP3, Dolby® Atmos), digital rights management (e.g., Google® WideVine, Microsoft® PlayReady, Adobe® Flash Access, Apple® Fairplay), adaptive bitrate video formats, and so forth.

A decoded digital image as output by the decoder 116 is then processed by a local renderer 118 to implement one or more additional rendering techniques for output of the digital image by a display device 120. The local renderer 118 is configurable in hardware (e.g., using an integrated circuit, an application specific integrated circuit), a combination of software that is executed on the hardware (e.g., a central processing unit, graphics processing unit, or other auxiliary processing device), and so forth. The local renderer 118 is configurable to expand functionality over that of conventional techniques that are limited to directly decoding and displaying the encoded digital image as received from the host device 102.

As part of expanding functionality available at the client device 104, the local renderer 118 includes an image construction controller 122, e.g., implemented in hardware and/or hardware/software of the local renderer 118. The image construction controller 122 is configured to reconstruct a decoded digital image received from the decoder 116 to expand functionality and richness of information received by the client device 104 from the encoded digital image 114. Examples of functionality to do so include illumination reconstruction 124 as implemented by the image reconstruction controller 122 to apply illumination effects to the decoded digital image. In another example, the image construction controller 122 is configured to perform asset recovery 126, e.g., in order to define shading within an environment captured by the decoded digital image by reconstructing geometry buffer (i.e., “G-buffer”) assets.

Functionality of the image construction controller 122 to reconstruct the decoded digital image received from the decoder 116 may be implemented in a variety of ways. A machine-learning model 128, for instance, is executable using one or more processing devices, e.g., central processing units, graphics processing units, and other hardware devices implemented using integrated circuits. A machine-learning model 128 refers to a computer representation that can be tuned (e.g., trained and retrained) based on inputs to approximate unknown functions. In particular, the term machine-learning model 128 can include a model that utilizes algorithms to learn from, and make predictions on, known data by analyzing training data to learn and relearn to generate outputs that reflect patterns and attributes of the training data.

The machine-learning model 128 is configurable in one or more examples to implement generative artificial intelligence 130, e.g., as a generative adversarial network, variational autoencoder (VAEs), recurrent neural network (RNN), and so forth. The machine-learning model 128 is trainable and retrainable using training data to perform a corresponding task based on the decoded digital image, such as of illumination reconstruction 124 of an environment captured by the decoded digital image, for asset recovery 126 as part of shading the environment, and so on.

In conventional remote rendering scenarios, digital images are encoded to increase suitability for communication via a network. However, this encoding in conventional techniques introduces technical challenges and reduces functionality in real world scenarios, including loss of high dynamic range support, use of geometry buffers to implement shading, and so forth. These technical challenges are further exacerbated by in scenarios involving support of local interaction at the client device 104.

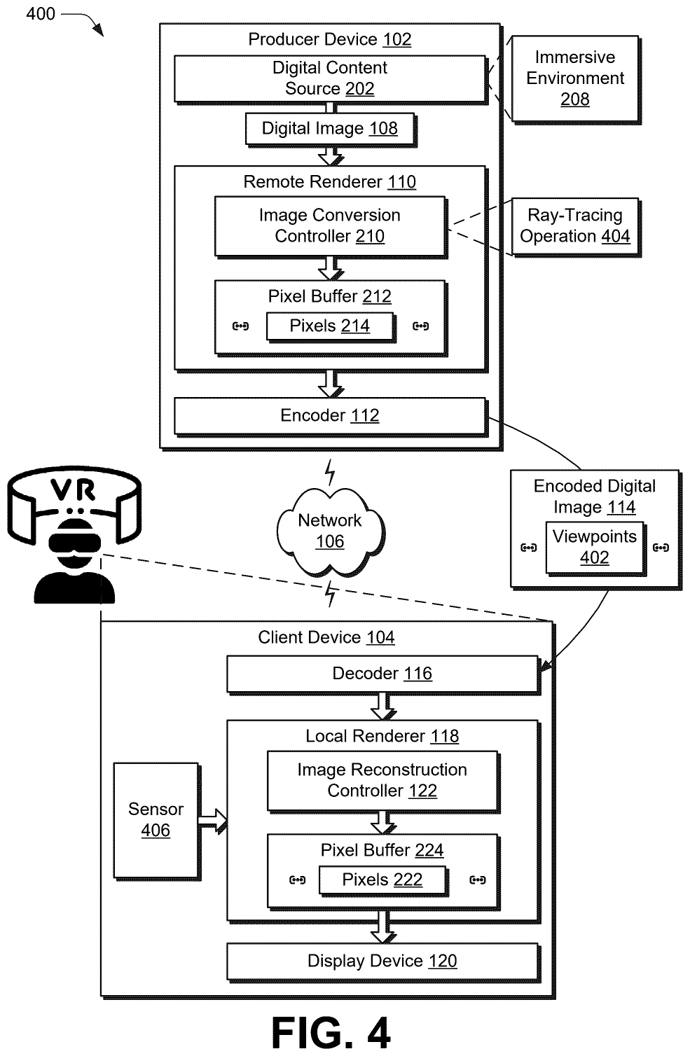

In an immersive environment employed for augment and virtual reality scenarios, for instance, inputs are generated locally at the client device 104 to control a viewpoint and corresponding field-of-view of the immersive environment, e.g., using one or more sensors as further described in relation to FIG. 4. The inputs are communicated over the network to the producer device 102, which causes the producer device 102 to render one or more corresponding digital images (e.g., as frames of a digital video) which are communicated back to the client device 104. This “round trip” of inputs and subsequent rendering in real world scenarios typically introduces lag and visual artifacts. In order to address these technical challenges and reduce lag, conventional techniques are configured to implement a number of compromises, such as reduced functionality (e.g., lack of high dynamic range support), lower frame rates, and so on.

In the techniques described herein, however, the image construction controller 122 is configured to reconstruct the decoded digital image to increase functionality available via the digital image, e.g., using illumination reconstruction 124, asset recovery 126, and so forth. These techniques, for instance, may be utilized in combination with a digital image as supporting a panoramic view of an environment such that local changes may be made to a viewpoint used to view the environment without the “round trip” involved in conventional techniques. Further discussion of these and other examples is included in the following description and shown in a corresponding figure.

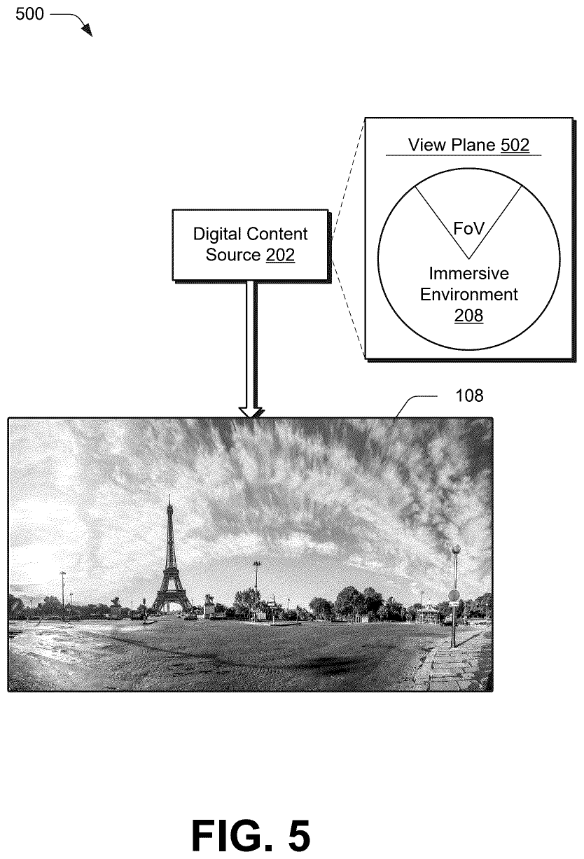

FIG. 2 depicts a non-limiting example 200 showing operation of the encoder 112 and decoder 116 of the producer device 102 and the client device 104 of FIG. 1 in greater detail. To begin in this example, a digital content source 202 outputs the digital image 108. The digital content source 202 is configurable in a variety of ways. In a first example, the digital content source 202 is configured as a digital camera 204, e.g., including a light sensor such as a charge-coupled device configured to capture a physical environment, in which, the digital camera 204 is disposed. In another example, an application 206 is executed (e.g., by a central processing unit or other processing device implemented using an integrated circuit in hardware) to generate the digital image 108. The application 206, for instance, is executable to generate an immersive environment 208 in support of an augmented reality or virtual reality environment. The digital image 108 is captured based a view plane defined in relation to the immersive environment 208, an example of which is further described in relation to FIG. 5.

The digital image 108 is then passed as an input to a remote renderer 110. The remote renderer implements an image conversion controller 210 (e.g., in hardware and/or hardware and software used to implement the remote renderer 110) as part of rendering the digital image 108. The image conversion controller 210 is configured to generate a final visual representation from data and instructions used to define the digital image 108 by the digital content source 202.

The image conversion controller 210, for instance, is configurable to apply textures, lighting, and viewpoint information to produce a two-dimensional image suitable for output by a display device 120. Other examples are also contemplated, such as to generate stereoscopic images in support of three-dimensional views. As part of rendering the digital image 108, the image conversion controller 210 is configurable to simulate interactions of light with objects defined within an environment captured by the digital image 108, shading and textures, and so on. Rendering of the digital image 108 in this example of digital content causes rasterization of the digital image 108 into a pixel buffer 212 as a plurality of pixels 214. Thus, in this example the renderer of the producer device 102 is referred to as a remote renderer 110 as supporting remote rendering of the digital image 108, which is also referred to as “cloud rendering” and “server-side rendering.”

The rendered digital image 216 is then output by the remote renderer 110 for encoding by the encoder 112 to form the encoded digital image 114. The encoder 112, for example, is configured to compress the rendered digital image 216 for transmission over the network 106 for receipt by the client device 104. The encoder 112 is configured to support a variety of video encoding formats (e.g., MP4) and video codecs (e.g., H.264). The encoder 112 is also configurable to support a variety of audio formats (e.g., MP3, Dolby® Atmos), adaptive bitrate video formats, and so forth.

The decoder 116 of the client device 104 is then tasked with decoding the encoded digital image 114 to generate a decoded digital image 218. To do so, the decoder 116 implements complementary functionality to that used by the encoder 112 to generate the encoded digital image 114, e.g., in support of a variety of video encoding formats (e.g., MP4) and video codecs (e.g., H.264). The decoder 116 is also configurable to support a variety of audio formats (e.g., MP3, Dolby® Atmos), adaptive bitrate video formats, and so forth.

In an implementation, the decoded digital image 218 results in generation of pixels 214 and respective color values. Other functionality may also be encoded as part of the encoded digital image 114, which is then made accessible via decoding by the decoder 116, e.g., geometry-buffer assets, high dynamic range pixels, and so on.

The client device 104, for example, may communicate client capability data 220 to the producer device 102, e.g., what machine-learning functionality is supported by the client device 104. Examples of machine-learning functionality include reconstruction of high dynamic range (HDR) pixels from standard dynamic range (SDR) pixels included in the encoded digital content. In a second example, geometry buffer (i.e., “G-buffer”) assets are reconstructed from the encoded digital content that are usable to implement shading locally at the client device. The geometry buffer assets, for instance, are usable to define albedo, normal vectors, depth, or secularity of the one or more objects in an environment captured by a digital image that are used as a basis to implement shading within the environment. A variety of other examples are also contemplated, including implementation of image-based lighting (IBL), global illumination effects, transient illumination effects, and so forth as part of local rendering performed at the client device.

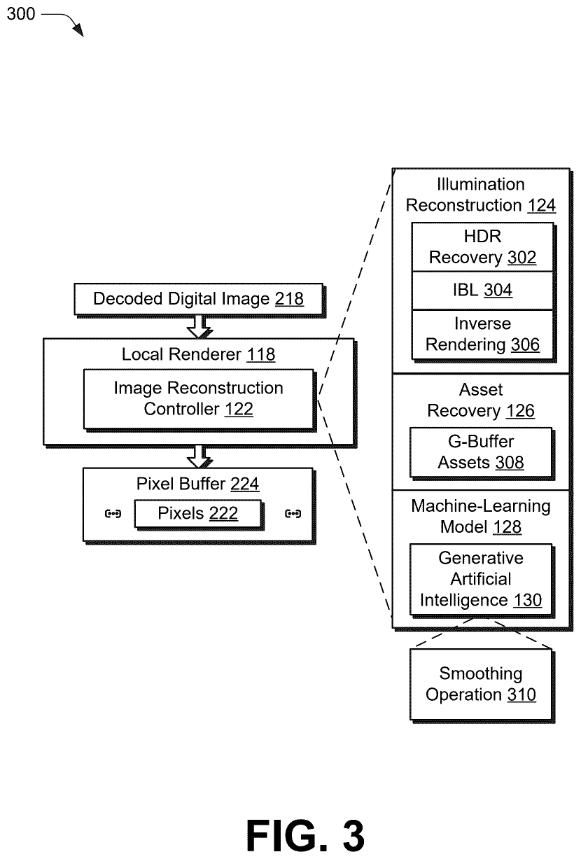

The remote renderer 110, and more particularly the image conversion controller 210, then adapts to functionality supported by the client device 104 and the local renderer 118 through use of the image construction controller 122. In an instance in which high dynamic range reconstruction functionality is available at the image construction controller 122, for example, the remote renderer 110 configures the encoded digital image 114 in a standard dynamic range as reducing an amount of data being communicated over the network 106, from a thirty-two bit representation to an eight-bit representation. Other examples are also contemplated, including use of geometry buffer assets as further described in relation to FIG. 3.

Continuing the previous example, the image construction controller 122 then employs the image construction controller 122 to output pixels 222 to a pixel buffer 224 that are reconstructed based on pixels included in the decoded digital image 218. To do so, the image construction controller 122 employs a machine-learning model 128 in the illustrated example to implement generative artificial intelligence 130 to generate the pixels 222 for display by the display device 120. The machine-learning model 128, for instance, is usable to infer characteristics of an environment being rendered based on the pixels within the decoded digital image 218, and from these characteristics, output pixels as reconstructing various aspects of the digital image. Further discussion of which is included in the following section and shown in a corresponding figure.

FIG. 3 depicts a non-limiting example 300 showing operation of an image construction controller 122 of a local renderer 118 of FIG. 2 in greater detail. The image construction controller 122, as previously described, is configured to perform a variety of reconstruction operations as part of local rendering of the decoded digital image 218.

The image construction controller 122, for instance, is configurable to perform illumination reconstruction 124. In a first example, high dynamic range (HDR) recovery 302 operations are performed. The encoded digital image 114, for instance, is encoded by the encoder 112 in one or more examples in a standard dynamic range (SDR) to reduce an amount of data used to communicate the encoded digital image 114, e.g., from a thirty-two bit high dynamic range to an eight bit standard dynamic range. To do so, the image construction controller 122 may employ the machine-learning model 128 (e.g., as a convolutional neural network, use of an encoder-decoder structure, and so on) to use generative artificial intelligence 130 to expand a tonal and luminance range of pixel values in the SDR of the decoded digital image 218 to approximate details available in the HDR.

In a second example of illumination reconstruction 124, the image construction controller 122 is configured to employ image based lighting (IBL) techniques 304. Image based lighting is performed by the image construction controller 122 using an environment map that includes luminance information capturing shadows and highlights from an environment captured by the decoded digital image 218. The image construction controller 122, when rendering the environment, then uses the lighting information along with reflection angles and surface normals defined for objects within the environment to render the output pixels 222 to the pixel buffer 224. In an implementation, the environment map is generated by the machine-learning model 128, e.g., using generative artificial intelligence 130, to predict the luminance information based on the decoded digital image 218.

In a third example of illumination reconstruction 124, the image construction controller 122 is configured to employ inverse rendering 306. Inverse rendering 306 is utilized to decompose the decoded digital image 218 into intrinsic properties such as shape, albedo (e.g., reflectance), and so forth. These properties are then used to define luminance and light transfer within an environment captured by the decoded digital image 218. In an implementation, the machine-learning model 128 is configured to predict these properties, e.g., though a deep learning approach implemented using a convolutional neural network (CNN).

The image construction controller 122 is also configured to perform an asset recovery 126 operation to reconstruct assets associated with the digital image. An example of these assets includes geometry buffer (i.e., “G-buffer”) assets 308 that are used as a basis to perform shading operations in an environment defined by the decoded digital image 218.

G-buffer assets 308 are utilized in deferred shading which delays a shading calculation during rendering until each object in an environment is processed. The G-buffer assets 308 define albedo (e.g., base color), normal vectors (indicating a direction associated with a surface), depth (e.g., distance from viewpoint), or secularity (e.g., shine of a surface) of objects in the environment defined by the decoded digital image 218. The G-buffer assets 308, once reconstructed, are then used to calculate shading by controlling how light interacts with surfaces of the objects within the environment. Accordingly, in this example, the machine-learning model 128 is trained to reconstruct the G-buffer assets 308 from the decoded digital image 218. The G-buffer assets 308 are then used as part of rendering the pixels 222 to the pixel buffer 224. As a result, the asset recovery 126 enables the image construction controller 122 to apply shading to pixels defined for the decoded digital image 218 that do not have this shading already defined.

A variety of other examples are also contemplated. The remote renderer 110 of the producer device 102, for instance, is configurable to perform path tracing (e.g., ray tracing) as part of generating the rendered digital image 216. In ray tracing, transmission of rays of light are modeled within an environment captured by the digital image. However, path tracing typically introduces noise (i.e., visual artifacts) in the digital image. Accordingly, the machine-learning model 128 is configurable to utilize generative artificial intelligence 130 as a smoothing operation 310 to remove the noise and improve image quality.

Therefore, in this example the remote renderer 110 of the producer device 102 is configured to perform the ray tracing wherein the smoothing operation 310 is performed through execution of the machine-learning model 128 at the local renderer 118 of the client device 104. In this way, rendering is decoupled and performed at least partially at both the producer device 102 and the client device 104. This decoupling supports a variety of functionality, including increased responsiveness, an example of which is described in the following discussion and is illustrated in a corresponding figure.

FIG. 4 depicts a non-limiting example 400 showing operation of an image construction controller 122 of a local renderer 118 of FIG. 2 in greater detail as part of an immersive environment. As previously described, conventional techniques are confronted with numerous technical challenges in implementing remote rendering. Examples of these technical challenges include latency in communication of the digital content in response to inputs received from the client device (e.g., as part of a video game), bandwidth limitations, limitations imposed by use of data compression that has a corresponding effect on quality of the digital content when displayed at the client device 104, and so forth.

These technical challenges are compounded in scenarios involving communications occurring back-and-forth between the producer device 102 and the client device 104, such as typically encountered in rendering an immersive environment 208. The immersive environment 208, for instance, is configurable to support augmented reality and/or virtual reality in which an entirety of the immersive environment 208 is generally not viewed at any one time but rather control is supported to “look around” using multiple viewpoints.

In order to increase efficiency as well as visual richness of a user experience in interacting with the immersive environment 208 along with efficiencies gained as part of remote rendering, the digital content source 202 is configured to generate the digital image 108 as a panoramic image that, when used to generate the encoded digital image 114, supports a plurality of viewpoints 402. As shown in an example implementation 500 of FIG. 5, for instance, the digital content source 202 is configured to generate the digital image 108 based on a view plane 502 for one or more viewpoints (depicted as having a respective field of view “FoV”) with respect to the immersive environment 208.

Returning again to FIG. 4, the digital content source 202, for example, traces viewpoints through a virtual, spherical camera to generate the digital image 108 from the immersive environment 208. The image conversion controller 210 is configured to perform a ray-tracing operation 404 or other computationally intensive tasks to render pixels 214 to the pixel buffer 212 based on the digital image 108. In an implementation, shading techniques may also be employed by the image conversion controller 210 at the remote renderer 110 using geometry buffer assets as previously described.

The encoder 112 is then used to generate the encoded digital image 114 based on the pixels 214 in the pixel buffer 212, which supports the plurality of viewpoints 402 in this example. In one example, the encoder 112 encodes the pixels 214 in accordance with VR180, which is a virtual reality video format that support a one-hundred and eighty degree panorama. The encoder 112 is also configurable to convert high dynamic range pixels into a standard dynamic range as part of a compression operation. The encoded digital image 114 is then communicated to the client device 104 via the network 106. The decoder 116 decodes the encoded digital image 114, which is then rendered locally by the local renderer 118 into pixels 222 in a pixel buffer 224.

In this example, the local renderer 118 is configured to respond to inputs received from a sensor 406 that detects movement to change viewpoints with respect to the digital image. The sensor 406, for instance, is configurable as a cursor-control device, touchscreen of a display device, accelerometer, or other hardware-implemented sensor usable to control navigation with respect to an immersive environment captured by the encoded digital image 114 and subsequently rendered locally for viewing by the display device 120. In this way, navigation and rendering is performable locally at the client device 104 without involving the “round trips” back and forth between the producer device 102 and the client device 104 as involved in conventional techniques. Further, through use of the image construction controller 122 increased image quality may also be achieved at a reduced data rate, e.g., the encoded digital image 114 may be communicated at a lower frequency when compared with conventional techniques.

The image construction controller 122 may also leverage image-based lighting (IBL) techniques as previously described to realistically illuminate locally rendered objects, such as a character avatar. The image construction controller 122 may further use inverse rendering techniques to cast transient illumination effects back out into the panoramic environment, such as a game character illuminating a dark corner with a torch, and so on. As a result, the client device 104, through use of the local renderer 118, is configurable to place and illuminate locally rendered objects and can cast local illumination effects back out into the environment. Client device 104 quality of experience is scalable with client capability and remote rendering capability may be increased to address additional client devices 104 as client-local rendering is offloaded using the techniques described. Network 106 bandwidth may also be reduced by having the client device 104 reconstruct G-buffer assets. Additionally, these technique support protection of the immersive environment 208 and associated assets by continued maintenance of these assets at the producer device 102.

It should be understood that many variations are possible based on the disclosure herein. Although features and elements are described above in particular combinations, each feature or element is usable alone without the other features and elements or in various combinations with or without other features and elements.

The various functional units illustrated in the figures and/or described herein (including, where appropriate, the producer device 102 and client device 104) are implemented in any of a variety of different manners such as hardware circuitry, software or firmware executing on a programmable processor, or any combination of two or more of hardware, software, and firmware. The methods provided are implemented in any of a variety of devices, such as a general purpose computer, a processor, or a processor core. Suitable processors include, by way of example, a general purpose processor, a special purpose processor, a conventional processor, a digital signal processor (DSP), a graphics processing unit (GPU), a parallel accelerated processor, a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), and/or a state machine.

In one or more implementations, the methods and procedures provided herein are implemented in a computer program, software, or firmware incorporated in a non-transitory computer-readable storage medium for execution by a general purpose computer or a processor. Examples of non-transitory computer-readable storage mediums include a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs).

Although the systems and techniques have been described in language specific to structural features and/or methodological acts, it is to be understood that the systems and techniques defined in the appended claims are not necessarily limited to the specific features or acts described. Rather, the specific features and acts are disclosed as example forms of implementing the claimed subject matter.

What is claimed is:

1. A device comprising:
a decoder implemented in hardware and configured to generate a decoded digital image from an encoded digital image; and
a renderer implemented in hardware and configured to reconstruct a digital image from the decoded digital image by rendering the decoded digital image using a machine-learning model.

2. The device of claim 1, wherein the digital image is panoramic as capturing a plurality of viewpoints of an environment and the renderer is configured to adjust a respective said viewpoint with respect to the environment captured by the digital image.

3. The device of claim 2, further comprising a sensor implemented in hardware to detect movement and wherein the renderer is configured to adjust the respective said viewpoint based on the detected movement.

4. The device of claim 1, wherein the machine-learning model is configured to reconstruct high dynamic range pixels of the digital image from standard dynamic range pixels included in the encoded digital image.

5. The device of claim 1, wherein the machine-learning model is configured to reconstruct illumination with respect to one or more objects in an environment captured by the digital image.

6. The device of claim 5, wherein the machine-learning model is configured to reconstruct the illumination using image-based lighting (IBL) or cast a transient illumination effect back into the environment.

7. The device of claim 1, wherein the machine-learning model is configured to reconstruct one or more geometry buffer assets from a geometry buffer configured to store geometric data of one or more objects in an environment captured by the digital image.

8. The device of claim 7, wherein the one or more geometry buffer assets define albedo, normal vectors, depth, or secularity of the one or more objects in the environment.

9. The device of claim 7, wherein the machine-learning model is configured to compute shading in the environment captured by the digital image using the one or more geometry buffer assets.

10. A device comprising:
an image conversion controller implemented in hardware and configured to receive a communication of client capability data describing machine-learning functionality supported by a client device and adapt conversion of a digital image into a rendered digital image based on the client capability data; and
an encoder implemented in hardware and configured to generate an encoded digital image for receipt by the client device based on the rendered digital image.

11. The device of claim 10, wherein the encoded digital image includes one or more geometry buffer assets from a geometry buffer configured to store geometric data of one or more objects.

12. The device of claim 11, wherein the machine-learning functionality is configured to compute shading using the one or more geometry buffer assets.

13. The device of claim 10, wherein the digital image depicts a virtual reality environment and the encoded digital image supports an adjustment to a viewpoint with respect to the virtual reality environment based on movement detected by a sensor.

14. The device of claim 10, wherein the machine-learning functionality is configured to reconstruct high dynamic range pixels from standard dynamic range pixels.

15. The device of claim 10, wherein the machine-learning functionality is configured to reconstruct illumination with respect to one or more objects.

16. The device of claim 15, wherein the machine-learning functionality is configured to reconstruct the illumination using image-based lighting (IBL).

17. The device of claim 10, wherein the machine-learning functionality is configured to reconstruct one or more geometry buffer assets from a geometry buffer configured to store geometric data of one or more objects.

18. The device of claim 10, wherein the encoded digital image is configured using path tracing and the machine-learning functionality, using generative artificial intelligence, is configured to smooth the path tracing.

19. A device comprising:
a decoder implemented in hardware and configured to generate a decoded digital image from an encoded digital image; and
a renderer implemented in hardware and configured to render the decoded digital image, the rendering including reconstructing illumination of one or more objects within an environment captured by the encoded digital image.

20. The device of claim 19, wherein the renderer is configured to reconstruct the illumination using image-based lighting (IBL) or cast a transient illumination effect back into the environment.
